(19) United States
(12) Patent Application Publication
(10) Pub. No.: US 2008/0250330 A1
(43) Pub. Date: Oct. 9, 2008

(54) Portable action processing software module with pre-designed expert action plans

(76) Inventor: Carl Thompson, Franklin, TN (US)

Correspondence Address: BARBER LEGAL, P.O. BOX 16220, GOLDEN, CO, 80402-6004, US

(21) Appl. No.: 11/899,403

(22) Filed: Sep. 5, 2007

Related U.S. Application Data
(63) Continuation-in-part of application No. 10/376,111, filed on Feb. 26, 2003, now abandoned.

(51) Int. Cl. G06F 7/10; G06F 17/30; G06F 15/16; G06F 3/048

(52) U.S. Cl. 715/751; 707/5; 715/810; 707/E17.014

(57) ABSTRACT

The present invention teaches a portable action processing software module with pre-designed/preprogrammed expert action plans. A database of action plans allows users to select more than a single course of contact management flow, much like a choice of logic flows would allow programmers to handle the same functions in very different ways, depending upon circumstances. The user may alter or add action plans as well. The action processing module may interoperate with a single contact management device such as a Personal Digital Assistant or contact management software on a desktop computer or server, and with the database of contact information and dates present in the contact management device. In the alternative the action processing module may interact with a plurality of contact management devices (including software package devices).

### CROSS-REFERENCE TO RELATED APPLICATIONS

The application claims the priority and benefit of co-pending U.S. patent application Ser. No. 10/376,111 filed Feb. 26, 2003 in the name of the same inventor, Carl Thompson and also entitled PORTABLE ACTION PROCESSING SOFTWARE MODULE WITH PRE-DESIGNED EXPERT ACTION PLANS, the entire disclosure of which in incorporated herein by this reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE INVENTION

This invention relates generally to business software and more specifically to interdatabase-portable software having pre-designed expert action plans.

### BACKGROUND OF THE INVENTION

This invention concerns software assisting business people with relationship building and maintenance, scheduling, follow-ups and the many assorted tasks which fall into the overall field of “Event Processing Software” for business. To further aid understanding of the background of this invention, it is quickest to provide an example taken from the sales area (it will be understood from the outset that the invention is not limited to the sales area).

Sales professionals may be familiar with “canned sales plans”. Rather than using personal memory and judgment to decide upon the various sales steps to be taken at any given time, a “canned” plan may have the following list of steps:
1) Initial “cold” call to prospect
2) E-mail note thanking prospect for speaking to sales representative—same day
3) Mail standard “follow-up letter”—send 2 days after steps 1 & 2
4) Request for face to face meeting—make request 3 days after step 3, for a date 1 week after date of request. Note date in monthly planner.
5) Face to face meeting & Inform sales manager of new prospect
6) Fax thank you note and answers to unanswered questions, same day as step 5.
7) Mail information packet #2
8) . . . .

It will be seen that this system is rather rigid: the sales representative is being given a “canned” approach to follow. The rationale for this is that there are “experts” who have pre-designed the system and who have “scientifically” or by experience determined the proper course of events to follow: “best practices” imposed by the “experts”. Indeed, there are countless such experts who make a great deal of money teaching such elementary skills, often with conflicting advice as to the exact types of steps to be followed. It will also be seen that there are glaring weaknesses with this structure.

First, it lacks flexibility: if the prospect asks at step 4 for a meeting in three months, not seven days, then the date cannot be noted in a monthly planner. In addition, the sales manager will not be informed of the new prospect for three months, unless the sales rep uses intelligence to break the sequence and inform the manager of the situation.

Second, such a plan relies upon human memory and execution to work. If the sales representative forgets about the “standard follow-up” letter at step 3, the prospect may be missing some crucial sales “hook” that would induce them to accept a later meeting.

Third, there is no apparent assistance provided to the sales representative in the execution of these tasks, and there are numerous types of tasks: phone calls, emails, letters, packets, meetings, fulfillment literature, information to sales managers, scheduling and so on are left up to human resources. One example is enough: the sales representative may be computer illiterate and never sends any emails. Another may hate typing up a thank you letter. Other tasks may be similarly annoying to a different given sales representative.

In addition, what works in one industry may not work in another. Techniques optimized for product sales may not work in the insurance agent's office, which may not work in a law firm, which may not work for a child immunization clinic, and so on. A special expert must be consulted in each industry, and often there are a number of competing “experts” available, forcing business managers to select among experts. Another result of this is that such canned plans are not widely available except perhaps in a few vertically integrated industries.

One alternative type of solution has been to give up on human experts and instead turn to software for much of the scheduling and event tasking.

One handy software package is the “scheduler” or “contact manager” or “contact management device”, or (herein) “TYPE A” software, a device now represented as countless Personal Digital Assistants (PDAs), on desktop computers, on laptop computers, and even on cell-phones and other devices now known or later developed. These are the coded or electronic circuitry equivalents of contact file or a paper calender, with a few bells and whistles which may greatly aid convenience, or may not. Such convenience items include audio alarms, or the fact that users may open the program and see a calender of the format presently desired: daily, weekly, monthly or otherwise, and regardless of format, all scheduled tasks and events are present. Very regular events may even be programmed to appear on the schedule automatically. These events are basically displayed as “to do” items which must be manually performed. The device in itself has no ability to perform these items nor to flexibly schedule later tasks. These fairly basic features may be greatly expanded, but at heart the software package of this family is fairly passive: it waits for the user to input the vast majority of events and contacts at human discretion. Maximizer, Telemagic, Jana Contact Manager, Goldmine, MS Outlook, ACT!, Corel TaskManager, various PDA desktops, PDAs themselves, and many others fall into this very handy but very limited category. (These are registered trademarks, the owners are in no way affiliated with the applicant.) It is worth noting at this time that in one way or another, some of these packages have, use, alter and maintain a database of the contacts. They may have other features which may be applied to the database. It goes without saying that most of these databases are NOT compatible in format with other databases and are thus not accessible by the engines which drive the databases of other contact management software vendors.

A higher level of capability is clearly possible in comparison to the software packages discussed above (“TYPE A” or contact management software), and thus a number of other products exist in the form of large expensive stand alone software packages (hereinafter “TYPE B” or “sales automation” software devices) which carry this scheduling within the code written by the user. For example, users seeking this TYPE B category of software may purchase Firepond, Onyx, On-contact Software, UpShot.com, Salesforce.com, Goldmine Automated Processing, SalesLOGIX, SIEBEL Systems, Relationship Manager, and the products of various competitors. (The registered trademarks cited belong to entities not associated with the applicant.) These sales automation programs represent a rigid sales model with command mandated activities and at the cost of eliminating much of the portability, convenience and general usefulness of the smaller and more basic software packages. In general, a user of this type of software will purchase the product and immediately begin the task of programming into it a rigid sales or business plan. Thus these packages represent only a foundation on which such a rigid plan may be constructed. Such plans may be quite difficult to create, resulting in an effective loss of capability as users (who are likely to be “people skills oriented” sales professionals and managers rather than “logic oriented” software engineers) rebel at the headaches created by attempting to learn basic programming skills. The longest action plans available on these products tend to run 25 steps or so at the absolute maximum. The advantage, however, is greater assistance with the task lists eventually created. For example, some event processing packages will send out an email automatically in conformance to such a program. Another TYPE B software package (Relationship Manager) performs batch processing of letters and envelopes in conjunction with the preprogrammed action plan, making use of the customer/prospect information database of the stand alone software package only. This particular item may also be programmed for non-sales force duties. Some of these systems provide the same rigid, single strand, integrated autoresponder type programs which will send a sequence of emails without regard to responses received. However, such integrated packages are non-interoperable among other-party vendors and software engines and databases. There are of course other disadvantages such as cost and difficulty of obtaining support which are associated with specialized and integrated software packages of any type, not just sales automation packages. It goes without saying that most of these databases are ALSO not compatible in format with other databases and are thus not usually accessible by and to the engines which drive the databases of other contact management software vendors.

There are even more difficulties with these products beyond the extremely protracted initial programming time and the cost of the stand alone package. Portability is lost, everyone in a sales force must conform to the new software, there is no feedback or altering of the plan during execution except at the work station or office intranet on which it runs, there is no known organized “over-view” system by which sales managers may monitor all sales representatives regardless of location of manager or representative, human notification to sales managers of most events is required and so on. The portability loss is particularly expensive: a successful sales plan manually programmed on a first system must be translated if a new system is later purchased. If a database also exists in the first system, it must be translated with difficulty to another system when the second system is implemented. Thus the porting work load is doubled: a first manual programming effort for the sales plan which runs the engine component of the system, and a (potentially manual) translation effort for the database component of the system.

Finally, the TYPE B products are all sharply geared towards the “sales” paradigm of business, not towards providing software which truly meets the needs of the broader business world, and conversion to other tasks may be extremely difficult.

Such first third-party contact management device may be selected from the group consisting of: contact management software, sales force automation software, software having a contact database, personal digital assistants having contact databases, enterprise software, and combinations thereof. In general, such devices may consist of hardware, client side software, server side software, proprietary software, personal computer based software, mainframe computer based software, personal digital assistant software, distributed processing software, and combinations thereof.

Some specific systems may now be considered.

U.S. Pat. No. 6,067,525 issued May 23, 2000 to Johnson et al for INTEGRATED COMPUTERIZED SALES FORCE AUTOMATION SYSTEM teaches a large stand alone software package consisting of tens or hundreds of subsystem/APIs and an event manager which detects changes in state characteristics of events within the overall systems and kicking off new actions based upon that. In clearer terms, this reference teaches a stand alone software device of TYPE B, a large and hard to program device geared towards driving sales representatives into lock step compliance with a costly preprogrammed plan. This software package teaches that a sales plan may extend beyond the stage of developing a relationship and into the stage of processing an order and/or maintaining a relationship, and thus offers a single integrated package to do just that. The '525 patent distinguishes itself from the prior art (see '525, Background of the Invention) by pointing out this full integration ('525, Summary of Invention). As an example, an event during one phase, in one subsystem, may initiate other events in other subsystems relating to other stages of the sales process. It also teaches a small number of notification messages which may be sent to sales supervisors. However, the numerous charts of the '525 patent detail a large number of subsystems of the completely integrated device of that patent, but fail to indicate the specified actions to be taken, the details of those actions, the source of information required for the actions, and other details of operation. Most importantly, the '525 patent does not indicate any interoperability of the engine of the '525 patent with the contact management software of third-party vendors, and does not indicate the ability to access the contact/date information of such third-party contact management software databases. This software may be thought of as eliminating the flexibility and convenience of the normal “contact manager” in favor of a single centralized database and software package to which all human users must conform.

US Patent Publication No. 2002/0120462 in the name of Good and dated Aug. 29, 2002, teaches another large, non-portable device. The system of the '462 reference allows the end user to program for themself a rigid sales plan, the plan is then usable only on the system of the '462 reference itself. It does not operate portably between third party vendor software packages, it does not interoperate between different third party systems, and while it allows the end user to program and manage their own campaigns, it does not offer the user pre-programmed sales and general business campaigns which the user may use without further programming.

The '462 allows the user to create: “series of contact management actions which the user sets up . . . . For example, when a prospect contact group purchases or contracts for one of the user's products or services and thus becomes a client, an action module designed for that situation can both change the contact group's status and also initiate an appropriate series of follow-up contacts and other actions.” This is the definition of a typical TYPE B system defined in this application: a large system which must be programmed (“set up”) by the user. The steps in this programming by the user are discussed in paragraphs 150 and 151 of the reference: “Preferably, when the user 102 runs a campaign, a campaign wizard module 144 is provided as shown in FIG. 15A such that the user can select, from among various available campaign masters 1501, the one that is appropriate for the user's current objective. After choosing a campaign master, the user employs the campaign wizard to target a definable collection of contact groups; assign users and their experience levels to the campaign 140, as shown in FIG. 15B; choose a particular date to start the campaign and create a schedule that works for the team, as shown in FIG. 15C; and to select, change, and/or preview the documents are required for the campaign, as shown in FIG. 15D. Making such choices creates a “campaign instance.” In other words, the “campaign masters” are not in fact finished pre-programmed campaigns. In particular, the user is expected to select the documents required for the campaign and create a schedule that works for the team in order to “create a campaign instance”. As used herein, the term pre-programmed campaign includes allowing the user to use the campaign without creating a campaign schedule nor selecting documents used in the campaign.

The '462 requirement that the end user, typically a sales person or manager, must do programming or scheduling is a very real drawback in the real world. Sales people tend to be “people oriented” people untrained in programming and extremely un-eager to engage in such tasks.

US Patent Publication No. 2003/0220805 published Nov. 27, 2003 in the name of Hoffman et al teaches that an end user must program for themself a rigid sales plan usable only on the system of the '805 reference itself, and thus is a “TYPE B” reference: a large, hard to use system not operable with any third party contact management software or databases. This reference does not operate portably between third party vendor software packages (The closest the '805 reference comes to true interoperability/portability with third party databases is that it may update ITS OWN database from a third party database (paragraph 98), but it lacks the ability to update and alter a third party database. For example, it cites the MLS database as a database from which it might update itself, but the MLS database is a large centralized server-side database which the device of the '805 reference would lack the authority to update.) Nor does the '805 reference device interoperate between different third party systems, and it does not offer the user pre-programmed sales and general business campaigns which the user may use without further programming.

US Patent Publication No. 2004/0083479 in the name of Bondarenko et al, published Apr. 29, 2004, teaches a system irrelevant to the present area of art. Found in USPTO class 719, the '479 reference does not deal with sales management software at all. The '479 reference in fact deals with a corporation's “contact center”, that is, the corporate customer service center or the like, normally having numerous people answering telephones or e-mails when customers choose to contact the center with tech-support questions, customer service needs, or when customers respond to advertisements or the like. In general, the '479 reference apparently teaches improved methods for dealing with both incoming telephone calls and also with incoming XML based communications, that is web-based communications from customers. It has nothing to do with sales management software of either TYPE A or of TYPE B. A keyword search may bring this item up, since it coincidentally uses terms similar to those used in the contact management industry.

There is another weakness inherent in the contact management systems of either TYPE A or TYPE B, including most or all of those listed above, a weakness which may not be obvious at first glance. In particular, these systems tend to become disorganized and fail at the point when a human must take action and then inform the contact management system. A first general issue is that there may be structural concerns. The human being may be able to receive the reminders to undertake a certain task, but be unable to effectively respond. For example, dedicated software packages tend to be accessible only from a small number of stations located at the offices of the firm owning the package. Use of such packages may also be opaque to many people who are not computer experts.

A second general issue is that the human being may be able to inform the computer system of the results of the human being's actions, but the programming is simply lacking for the computer to then react appropriately. For example, the reminder may be: “Follow-up Call.” And the computer allows the sales rep to respond “Call made? Comment:”. However, in actual operation, the comment field accomplishes nothing. A response such as the comment, “Prospect states will buy our product but on condition we not call again until after the first of the month” is absolutely meaningless to the computer.

Thus it would be preferable to provide a system with highly interactive work flow structures allowing the human users to not only be prompted to carry out a task (one example of “an action” as used herein) but also given a wide latitude in reporting and further contact management options based upon the real world events and actions which transpired. It would be preferable if such a system might be accessible from a wide range of devices, for example, any device able to accept and send email, regular mail, promotional materials, text messages, SMS messages, DTMF tones, web forms and so on.

It would further be preferable if such a system could work in a uniform and seamless manner even though it might be called upon to work with either TYPE A or TYPE B software suites such as listed above, or even other types of software devices: accounting programs, word processor merge files, general purpose databases, or any other database in possession of a date and/or contact database.

### SUMMARY OF THE INVENTION

General Summary

The present invention teaches a portable action processing software module with pre-designed/preprogrammed expert action plans. A database of action plans allows users to select more than a single course of contact management flow, much like a choice of logic flows would allow programmers to handle the same functions in very different ways, depending upon circumstances. The user may alter or add action plans as well. The action processing module may interoperate with a single contact management device such as a Personal Digital Assistant or contact management software on a desktop computer or server, and with the database of contact information and dates present in the contact management device. In the alternative the action processing module may interact with a plurality of contact management devices (including software package devices).

An action processing engine is operatively connected to and capable of accessing and altering the database of one or more different third-party software vendors. It may do this by means of the contact management software normally used to access the third-party database, or by directly accessing the third-party database itself. Thus phrases used herein such as “first and second third-party databases” may refer to software devices offered by more than one vendor other than the vendor of the present invention.

The software may include a number of standardized forms to use with the action plans, and certain actions to be initiated by the software may consist of taking one such standard form, merging data from a user's database regarding the user, a client, the situation, etc, and then automatically producing the desired document, whether it is an e-mail message or other electronic communication, a script for a conversation, a text message, a printed document or another type of document.

Another unique feature of the present invention is the ability of an action plan to alter the future actions to be initiated based upon intelligent feedback from the user. In one embodiment, the user may “check off” boxes on an email form in order to provide such feedback which may automatically initiate a subsequent chain of events.

Indeed, the initiation of the feedback email form to the user may itself be one action automatically carried out by the device of the present invention either in response to scheduling or potentially even in response to an earlier “check off” response by the user. By this means, the users and the system may respond to circumstances in a very flexible manner akin to a human conversation.

Use of an email form is not the only possible form of feedback response: other formats might include manual, telephonic, or electronic forms and responses.

Users need not be sales representatives: unlike traditional contact management software, the present invention may be utilized at multiple levels including representatives, clerks, supervisors, executives and others.

By use of the present invention, users may maintain and nurture a much larger set of contact relationships than otherwise would be possible, because the invention automatically selects and generates communication and follow up, thus freeing user time.

Summary in Reference to Claims

It is therefore one aspect, advantage, embodiment, and objective of the present invention to provide a computer implemented action processing module for use with at least one third-party contact management device and associated third-party database containing contact information, the module comprising: an action processing engine, the action processing engine operatively connected to a first third-party contact management device as a plug-in module, the action processing engine furthermore operatively connected to a first associated third-party database so as to access and alter such contact information; and an action plan database containing a first action plan, the action plan indicating at least one action associated with specified combinations of the contact information and at least one date; wherein the action processing engine searches the first third-party database for the specified combinations of the contact information and date; and upon finding the specified combinations, the action processing engine initiates the associated actions.

It is therefore one more aspect, advantage, embodiment, and objective of the present invention to provide action processing software wherein the action processing engine is operatively connected to the first third-party contact management device by a first module to contact management device interface.

It is therefore one more aspect, advantage, embodiment, and objective of the present invention to provide an action processing software wherein the action processing engine is operatively connected to the first associated third-party database by a first module to database interface.

It is therefore one more aspect, advantage, embodiment, and objective of the present invention to provide an action processing software wherein the first module to contact management device interface is able to operatively connect the first module to a second third-party contact management device.

It is therefore one more aspect, advantage, embodiment, and objective of the present invention to provide an action processing software wherein the first module to database interface is able to operatively connect the first module to a second third-party database.

It is therefore one more aspect, advantage, embodiment, and objective of the present invention to provide an action processing module wherein the action processing engine is operatively connected with a first third-party contact management device having a first third-party database and with a second third-party contact management device having a second third-party database, and further wherein the action processing engine searches the first and second third-party databases for the specified combinations of the contact information and the associated dates; and further wherein upon finding the specified combinations in either one of the first and the second third-party database, the action processing engine initiates the associated actions.

It is therefore one more aspect, advantage, embodiment, and objective of the present invention to provide an action processing module wherein the action processing engine is operatively connected with a first third-party database and with a second third-party database, and further wherein the action processing engine searches the first and second third-party databases for the specified combinations of the contact information and the associated dates; and further wherein upon finding the specified combinations in either one of the first and the second third-party database, the action processing engine initiates the associated actions.

It is therefore one more aspect, advantage, embodiment, and objective of the present invention to provide an action processing module further comprising: a search module able to search through the action plan and further able to search through the database and retrieve therefrom information organized by one member selected from the group consisting of: the associated actions, the dates of associated actions, individuals associated with the associated actions, any data field present in the databases being searched, and combinations thereof.

It is therefore one more aspect, advantage, embodiment, and objective of the present invention to provide an action processing module further comprising means for communication between the action plan and at least one human being.

It is therefore one more aspect, advantage, embodiment, and objective of the present invention to provide an action processing module wherein the means for communication between the action plan and at least one human being further comprises at least one member selected from the group consisting of: notifying an individual associated with an action of the need to undertake the action, updating the information in an action plan, updating such contact information in the third party database, requesting updates of real world actions from individuals associated with an action, updating contact information in a personal database associated with an individual associated with an action, automatically merging data from such third party database with data from the action plan, automatically sending e-mail, automatically sending voice messages, automatically printing written communications, automatically sending facsimile transmissions, automatically sending text messages, requesting signing of automatically printed documents, requesting mailing of automatically printed documents, and combinations thereof.

It is therefore one more aspect, advantage, embodiment, and objective of the present invention to provide an action processing module wherein the at least one human being further comprises one member selected from the group consisting of: users, clients, customers, supervisors, and combinations thereof.

It is therefore one more aspect, advantage, embodiment, and objective of the present invention to provide an action processing module wherein the action plan database further comprises: a second action plan.

It is therefore one more aspect, advantage, embodiment, and objective of the present invention to provide an action processing module wherein first action plan is pre-programmed based upon the needs of a target class of likely users of the invention.

It is therefore one more aspect, advantage, embodiment, and objective of the present invention to provide an action processing module further comprising: a form library containing a plurality of forms pre-programmed based upon the needs of a target class of likely users of the invention.

It is therefore one more aspect, advantage, embodiment, and objective of the present invention to provide an action process module further comprising: a form processing module capable of undertaking at least one action selected from the group consisting of: automatically merging data from such third party database with data from the action plan, automatically sending e-mail, automatically sending voice messages, automatically printing written communications, automatically sending facsimile transmissions, automatically sending text messages, requesting signing of automatically printed documents, requesting mailing of automatically printed documents, conversion of automatically created documents to a specified file type, saving of automatically created documents, and combinations thereof.

It is therefore one more aspect, advantage, embodiment, and objective of the present invention to provide an action processing module further comprising: a human interface module capable of sending and receiving a message, the type of message being one member selected from the group consisting of: e-mail messages, text messages, voice mail, printed communications and combinations thereof.

It is therefore one more aspect, advantage, embodiment, and objective of the present invention to provide an action process module further comprising a response module capable of sending and receiving back from a user an after-action feedback form, the after action feedback form having means for selecting at least one member of plurality of outcomes of an action.

It is therefore one more aspect, advantage, embodiment, and objective of the present invention to provide an action processing module wherein the action processing engine is capable of altering the first action plan based upon the selected outcome of the action.

It is therefore one more aspect, advantage, embodiment, and objective of the present invention to provide an action processing module wherein the action processing engine is capable of departing from the first action plan and initiating a second action plan based upon the selected outcome of the action.

It is therefore one more aspect, advantage, embodiment, and objective of the present invention to provide an action processing module further comprising: a central information center allowing real time access to and review of the action plan database, the first action plan, the contact information database, and combinations thereof.

It is therefore one more aspect, advantage, embodiment, and objective of the present invention to provide an action processing module wherein the first third-party contact management device is one member selected from the group consisting of: contact management software, sales force automation software, software having a contact database, personal digital assistants having contact databases, enterprise software, and combinations thereof.

It is therefore one more aspect, advantage, embodiment, and objective of the present invention to provide an action processing module wherein: one member selected from the group consisting of: the third-party contact management device, the associated third-party database, and combinations thereof, is selected from one member of the group consisting of: hardware, client side software, server side software, proprietary software, personal computer based software, mainframe computer based software, personal digital assistant software, distributed processing software, and combinations thereof.

It is therefore one more aspect, advantage, embodiment, and objective of the present invention to provide an action plan database for users of contact management software which manages dates and contact information, the database comprising: a plurality of action plans, the action plans indicating at least one action associated with specified combinations of such contact information and such dates; wherein the action plans are operatively connected to the contact management software; and wherein users may select at least one action plan for use with the contact management software.

It is therefore one more aspect, advantage, embodiment, and objective of the present invention to provide an improved action plan for contact management software, wherein the improvement comprises: a response module capable of sending and receiving back from a user an after-action feedback form, the after action feedback form having means for selecting at least one member of plurality of outcomes of an action, wherein the contact management software is capable of altering the first action plan based upon the selected outcome of the action.

It is therefore one more aspect, advantage, embodiment, and objective of the present invention to provide an improved contact management device, wherein the improvement comprises: a form processing module capable of undertaking at least one action selected from the group consisting of: automatically merging data from such third party database with data from the action plan, automatically sending e-mail, automatically sending voice messages, automatically printing written communications, automatically sending facsimile transmissions, automatically sending text messages, requesting signing of automatically printed documents, requesting mailing of automatically printed documents, conversion of automatically created documents to a specified file type, saving of automatically created documents, and combinations thereof.

### BRIEF DESCRIPTION OF THE DRAWINGS

FIG. 1 is a block diagram overview of a software device according to a first embodiment of the present invention.

FIG. 2 is a block diagram overview of an action plan according to a second embodiment of the present invention.

FIG. 3 is a block diagram detailing one portion of a single phase of a single much larger action plan according to a third embodiment of the present invention.

FIG. 4 is an example of an action notice according to a fourth embodiment of the present invention.

### DETAILED DESCRIPTION

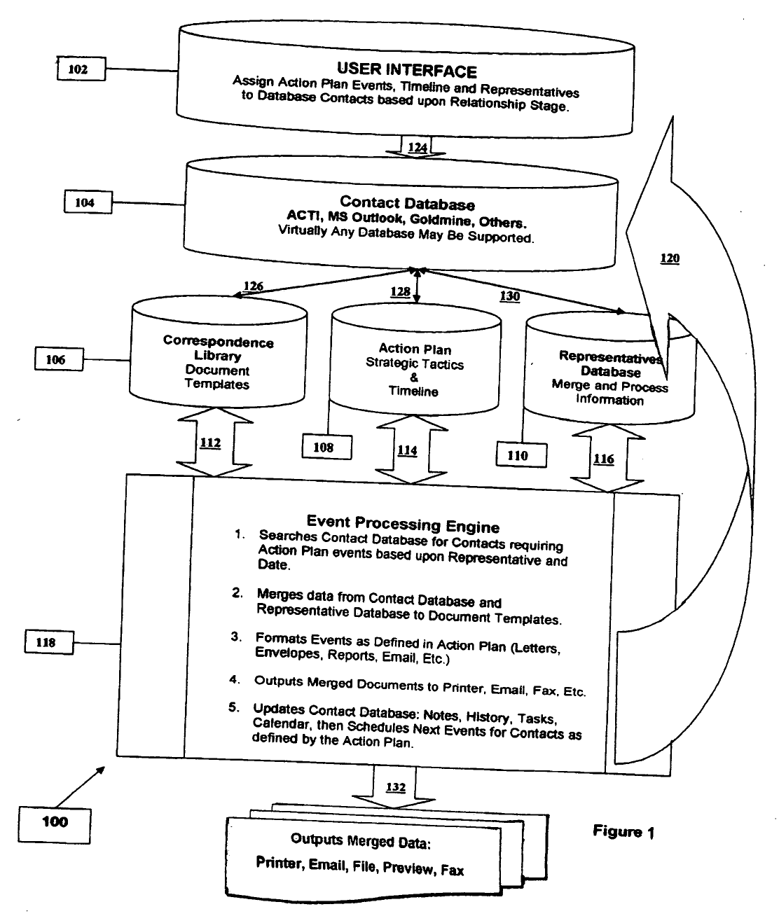

FIG. 1 is a block diagram overview of a software device according to a first embodiment of the present invention. The invention in the presently preferred embodiment and best mode now contemplated may comprise user interface 102, contact database 104, correspondence library 106, action plan database 108, user/representative database 110, event processing engine 118, and output and output module 122. Arrows and lines 112, 114, 116, 120, 124, 126, 128, 130 and 132 are used to indicate major operative connections between the major components of the invention.

In general the invention is a computer implemented action processing module 100 for use either with a dedicated database of its own offering contact information, or for use with third-party contact management device and associated third-party database containing contact information. The module has an action/event processing engine 118 operatively connected to either a dedicated database of its own or to a third-party contact management device as a plug-in module. Action processing engine 118 is furthermore operatively connected to a first associated third-party database so as to access and alter such contact information, either directly or via the third-party contact management device. Note that in contrast to the '805 reference, the present invention has the ability to alter the third party database, offering true interoperability. In addition, the device of the present invention offers the ability to ride as a plug in module on other software systems of TYPE A or B, thus functioning as an add-on to systems already in use and known to the sales professionals, unlike the '805 reference which is a typical tightly proprietary system which must be used instead of third party databases and systems.

The term computer implemented includes the fact that the software modules (including engines, modules, databases and so on) of the device may be stored in machine-readable form on magnetic, optical or other types of storage media.

In contrast to known systems which offer only a foundational ability for the user to program an action plan for later use, the invention offers not only programming tools but also a database of pre-programmed action plans which are usable without further programming or scheduling by the end user.

This is in contrast to the “campaign masters” of the '462 reference which at the very least must be “scheduled” and have “documents selected” by the user, and which to all appearances must apparently be in fact programmed by the user based upon the masters. The present invention allows the user to do this if they want to, but the present invention specifically provides the user the ability to use the action plans “off the shelf”, without any user programming nor user scheduling. This difference helps account for the commercial success of the device of the present invention, which is reasonable as the difference is crucial. This is because sales people tend to be “people oriented” people who dis-like and are inefficient programmers.

Action plan database 108 contains at least one action plan, the action plan indicating at least one action associated with specified combinations of the contact information and at least one date. Action processing engine 118 searches the first third-party database either directly or by means of the third-party contact management software/device, searching for the specified combinations of the contact information and/or date and/or specified representative and upon finding the specified combinations, the action processing engine initiates the associated actions. Associated actions specifically include but are not limited to reminding human users of actions to take or communications to be drafted, creating such communications via merging of information in various databases, sending such communications, requesting feedback from human users and combinations of these, and the associated actions further comprise at least one member selected from the group consisting of: notifying an individual associated with an action of the need to undertake the action, updating the information in an action plan, updating such contact information in the third party database, requesting updates of real world actions from individuals associated with an action, updating contact information in a personal database associated with an individual associated with an action, automatically merging data from such third party database with data from the action plan to create messages of various types, automatically sending e-mail, automatically sending voice messages, automatically printing written communications, automatically sending facsimile transmissions, automatically sending text messages, requesting signing of automatically printed documents, requesting mailing of automatically printed documents, and combinations thereof. Thus in information processing terms, a wide variety of associated actions are possible. In general these may be divided up into several broad categories: notifications to human users to undertake an action, automatic action on the part of the device, requests for feedback, supervisory measures, and “housekeeping” measures such as updating a database daily, compacting unorganized file space and so on.

In order to do all this when using a “foreign” (third-party) software suite or database, action processing engine 118 is operatively connected to the first third-party contact management device by a first module to contact management device interface. Such an interface is a typical low level program largely responsible for translating commands and data from one format to another and for interacting with the interfaced programs in order to cause them to carry out requested data manipulations. In other embodiments, the action processing engine is operatively connected directly to the first associated third-party database by a first module to database interface, thus bypassing third-party contact management devices. In yet other embodiments, the first module to contact management device interface is able to operatively connect the first module to a second third-party contact management device, so for example a representative database kept in one format (such as a Microsoft WORD merge file) might be accessed for one item of data while a contact database such as Front Range Corporation's GOLDMINE (from a different third-party vendor) might be accessed for different data, and a database/device of the type of ACT! (by Best Software Corp) accessed for a third item prior to use of Microsoft OUTLOOK to communicate the resulting document. Obviously in yet other embodiments the first module to database interface is able to operatively connect the first module to a second third-party database directly, without using the third-party contact management software such as ACT! or GOLDMINE.

User interface 102 may use any of an extremely broad range of other products in order to communicate with users, this is one major advantage of the present invention over known devices. For example, user interface 102 may communicate with users by means of email or voice messages sent to the user's email accounts/programs/in-boxes or voice mail systems. It may even print out messages automatically for human distribution to the physical in-boxes located in many offices or on many desks. It may also send Hypertext Markup Language, XML, XHTML, or similar documents, including forms, interactive media, animations, “flash” media and so on, thus allowing an extremely great degree of interactivity. Portability of message receipt is further increased by allowing use of SMS, MMS, pages, text messages and other similar systems used with a wide range of mobile information products including but not limited to PDAs (Personal Digital Assistants), cellular telephones, pagers, portable computers, and others. A wide range of such “batch mode” communications from and to users is thus enabled.

The user interface may further be accessed in a real-time mode by means of personal computers, servers, main-frames, terminals and other devices programmed to allow such immediate user interface. In one preferred embodiment of the present invention, such interface may occur via web-page (note that this mode of communication may be considered to be either batch mode (as previously discussed) or interactive). In this event, a user may access the device of the present invention via web-page, provide to the action plan usable feedback, make such changes to the contact database, correspondence library, action plan or representative database as are desired, order outputs or messages to other users and so on. The invention may send (in embodiments) a number of types of messages, including but not limited to one member selected from the group consisting of: e-mail messages and/or other electronic communications, text messages, voice mail, printed communications and combinations thereof. Instead of sending such a message, it may be saved, before or after conversion into any of a number of document formats: .pdf, .doc, .rtf, .wpd, .xls, .jpg, .bmp, .avi, mpg, .dbs, and so on. Thus a user who had carried out an action in an action plan while traveling might receive the feedback form for that action on a PDA or cellular telephone and be able to respond to the message by the same method.

Another unique aspect of the present invention is the fact that user interface 102, event processing engine 118 and other portions of the device (such as databases 106, 108, 110) may in fact function as “plug-in” modules to another software package offered by a third-party. For example, while in one embodiment contact database 104 may be the database offered with the invention, in the same or another embodiment contact database 104, or another database (106, 108, 110) may be the product of a third-party vendor. In the alternative, the device of the present invention may cooperate not with a database of a third-party vendor but with the entire software device of the third-party vendor. Thus, in one presently preferred embodiment, the device of the present invention cooperates with the entire ACT! (Trademark of Best Software Corp. and not associated in any way with the present applicant) software package as a seamless plug-in both in terms of the contact database 104 and the functionality of both software devices. Thus, contact database 104 may be considered to be a pure “database” or may be a software product having its own functionality offered by another vendor. The same holds true of correspondence library 106, action plan database 108 and representative database 110. Note that there are not presently action plan databases known or on the market (this being one point of the present invention). In this example, a user might initiate the third-party software suite (e.g. ACT!) without being aware that they were actually using two different programs: ACT! and also the device of the present invention, which would function “within” ACT! to offer enhanced features (as described in this disclosure) not normally available in ACT!. The device of the invention would in this embodiment offer some of its own functions by means of access to the functions of ACT!, and use ACT! to access the database supplied therewith, while offering other features (automatic printing, faxing, e-mailing, feedback generation and response, reminder message generation and so on) by means of its own functionality.

While in the preferred embodiment 100 pictured in FIG. 1, the invention is illustrated using a single database of each type, users may elect to utilize the device of the present invention with more than one such database, or with multiple databases offered by multiple third-party vendors. Thus the invention might be used with a software package/database of a first third-party vendor and another software package/database of a second third-party vendor.

A form processing/output processing module is further incorporated in the preferred embodiment of the invention, though it may be eliminated in simpler/cheaper alternative embodiments. The output/form processing module is capable of undertaking at least one action selected from the group consisting of: automatically merging data from such third party database with data from the action plan, automatically sending e-mail, automatically sending voice messages, automatically sending facsimile transmissions, written communications, automatically sending text messages, requesting signing of automatically printed documents, requesting mailing of automatically printed documents, conversion of automatically created documents to a specified file type, saving of automatically created documents, and combinations thereof. By this device, a very large amount of work may be accomplished “by a user” automatically, and the user merely informed before, concurrently or after the fact of what action has occurred.

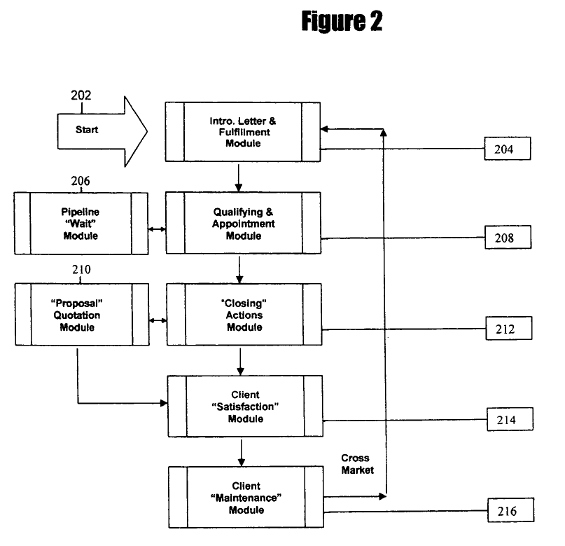

FIG. 2 is a block diagram overview of an action plan according to a second embodiment of the present invention. Action plan 200 comprises a number of broad phases of actions, each shown as one module. Thus, the blocks pictured are not specific actions but rather phases of operation of the device of the present invention. Each phase may be one or a very large number of actions. Large action plans prepared according to this embodiment of the present invention already have 500 steps or more, but considerably larger action plans are supported in this embodiment in which the number of actions may be unlimited. Note that since flow through the action plan is flexible and based upon feedback from human users/representatives, many or most alternative steps will not be executed in the typical action plan. However, most of the broad phases of FIG. 2 are likely to be executed.

Start phase 202 is largely self explanatory and involves among other actions entering the minimum information required to commence activities into the device of the present invention. Intro letter and fulfillment module 204 provides for initial communications with a contact, and comprises such known steps as sending an introductory letter, a follow-up telephone call, other forms of follow-up and so on. (These steps individually or collectively are not the substance of the present invention.) Pipeline “wait” module 206, qualifying and appointment module 208, “proposal” quotation module 210, “closing” actions module 212, client “satisfaction” module 214 and client “maintenance” module 216 all represent various known phases of operations in commercial negotiations. While the overview action plan shown in FIG. 2 is directed towards sales, it is worth emphasizing once again that the device of the present invention may be used in any type of scheduling, contact management, client management, patient management setting, docketing situation.

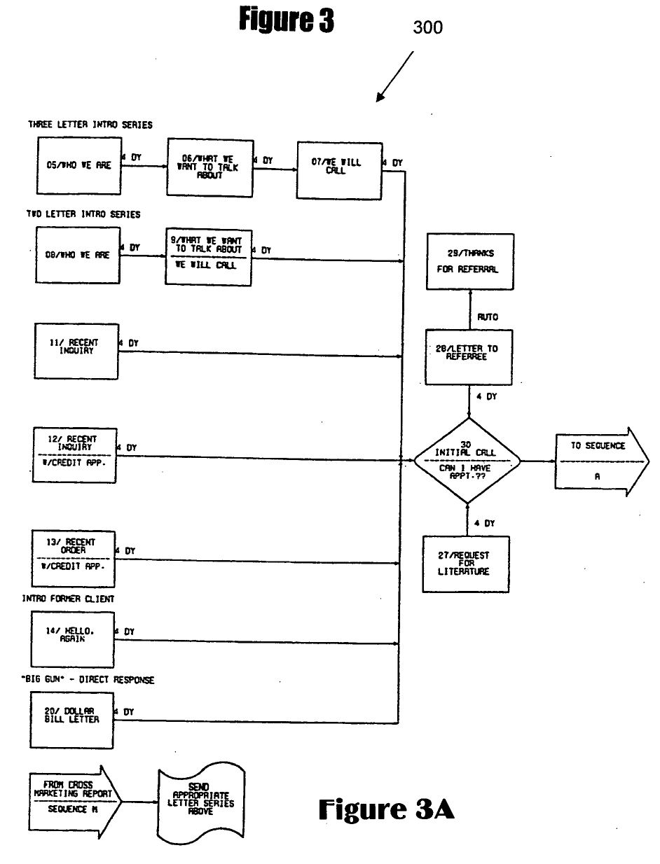

FIG. 3 is a block diagram detailing one portion of a single phase of a single much larger action plan according to a third embodiment of the present invention, although many other embodiments having sets of different steps or overlapping sets of steps may be implemented. The steps/events/actions shown in FIG. 3 may in some embodiments all occur inside of the introduction module 202 of FIG. 2. In FIG. 3, the annotation “4 DY” indicates a four day lapse between actions. Note that in the appended claims and this disclosure, dates may refer to absolute or relative dates such as “Jan. 18, 2004” or “tomorrow” or “the day after action 709 is carried out.” Several different sequences are indicated. A three letter introduction sequence begins with action 5, a “who we are” letter, followed after a four day interval with action 6, a “what we want to talk about” letter, and after another four days, action 7, “we will call”. Four days after action 7, action 30, “initial call/Can I have an appointment?” follows, and the action flow continues in a new portion of the action plan, sequence A. Other possibilities are indicated in the action plan: action 8, a “who we are” letter in a two letter introduction sequence, action 9, a combined “what we want to talk about/we will call” letter, action 11, a recent inquiry letter, action 12, a recent inquiry plus credit application letter, action 13, a letter appropriate to the situation in which a recent order has been placed, combined with a credit application, action 14, a letter appropriate to re-awakening ties with an ex-client, action 15, a direct response letter having a dollar bill in it, action 20. It will be appreciated that these letters may be transmitted via mail, E-mail, fax, SMS and by other means. Other forms of communication other than a letter (such as a call) may be utilized in other action plans.

Action 28 is a letter to a new reference from a known contact, while action 29 is a thank you letter to the known contact appropriate for the reference. Action 30 is an initial call. Action 27 would correspond to a client having previously asked for literature.

Entry to this sequence could come via cross marketing, another sequence of actions in the overall action plan, in which case one or more of the above actions could be initiated. Such initiation could be handled automatically by the computer based upon contextual clues of the cross market lead or might be a choice made by a human being in feedback to the original lead to the new contact.

FIG. 3 is rendered as a flow chart but it is functionally an overview of a sequence (in this case a group of choices of introductory sequences) of actions to be followed in a sales context. It does not indicate a rigid set of programming. Rather FIG. 3 is a detail of a portion of an action plan. Exiting FIG. 3, work flow may proceed to Sequence A as shown by FIG. 3, or work flow may leap from to any of the modules depicted in FIG. 2. This powerful flexibility is made possible by user feedback/response occasioned after action 30, as will be discussed below.

In terms of “real world” steps occasioned by the use of such an action plan, the three letter introduction series may be used as an example.

The user may have selected automatic initiation and creation of the three letter introduction series. On that basis, the device of the present invention (in particular the event processing engine 118 of FIG. 1) will automatically search the contact database according to the rules of the action plan portion 300/action plan database 128 and determined that action 5 is appropriate. The device may then merge data from the contact database 104 with a document/template taken from local, remote, or online correspondence library 106 and automatically print it out, either with the signature of the representative (found in representative database 110) assigned to the management of the contact, or with an annotation that the letter be sent to the representative/user for their signature. The invention may automatically facsimile transmit such a communication. The device may (in the context of dedicated physical plants capable of automatic mailing) send the letter, or it may at the time of printing annotate the letter for manual mailing or manual faxing. E-mail, SMS, or other electronic methods may also be used to transmit the letter. Normally action then proceeds to action 6 when after a four day interval event processing engine 118 again detects a congruence of date and action in an action plan. Creation, processing and transmission in action 6, and four days later in action 7, may be much as those of action 5, or they may be different. For example, action 7 might be an email message automatically sent in the name of the user. Or in another alternative embodiment, action 6 may require human input in the creation of the document, input requested by means of a feedback form sent prior to completing action 6. In simple embodiments, no part of the document creation need be automated, and actions 5, 6 and 7 may simply consist of sending prompts to the user to undertake the task manually.

Action/event 30 in this part of this module of the action plan is normally a manual telephone call but may also be an automated activity. Assuming that it is manual, the user may receive a message via email, voice mail, text message to pager or other method prompting the call. In other embodiments, the user may in addition receive the complete file on the contact automatically abstracted from contact database 104, and in yet other embodiments may also receive a ‘script’ or merely notes on the course of the conversation, this being automatically abstracted from correspondence library 106.

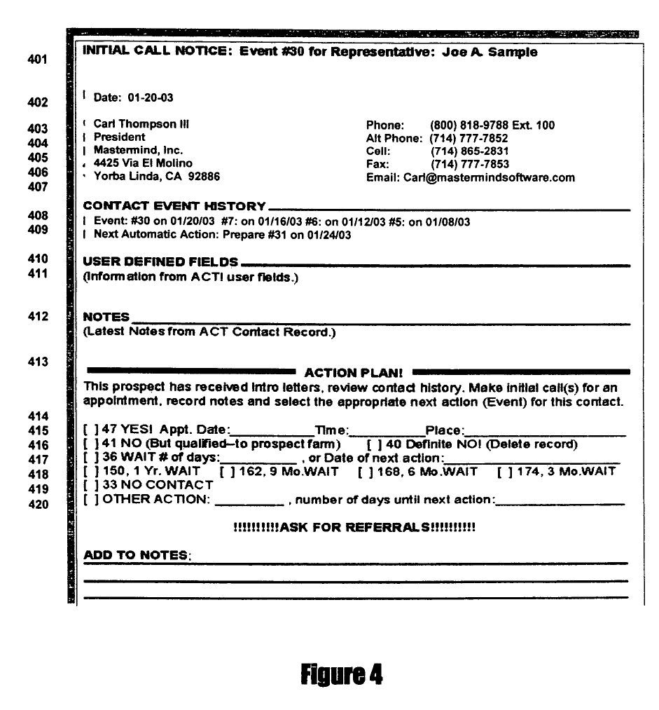

At action/event 30, the system may further send a feedback form to the user informing them of the mailing of the letter and requesting feedback, a process discussed in much greater detail in regard to FIG. 4. The response to the feedback request may entirely alter the sequence of flow of the actions: instead of sequence A, the human user may indicate that some action in some entirely different module/phase of operations may be called for. For example, action 30 may generate an instant customer order, which would necessitate skipping to some much higher numbered action (not shown in FIG. 3 but one possible action within module 212 of FIG. 2) for taking an order.

As noted previously, the intro letter (generated at action 5) is not new, nor is the automatic sending of an advertisement letter by mail. However, integrating automatic creation of an individual letter into a feedback responsive action plan is one point of invention of the present device.

In general, users will benefit from receiving a pre-designed, pre-programmed and completely “off the shelf usable” expert action plan which indicates the proper relationship or contact management action to undertake at any given stage of the relationship or time, and flexibly responds to circumstances. Action plans may be pre-programmed based upon the needs of a target class of likely users of the invention. (The form library may contain a large plurality of forms pre-programmed based upon the needs of a target class of likely users of the invention as well.) More specifically, however, the action plan followed in a single case may not be appropriate to all cases, and thus users benefit even more from receiving an entire database of action plans from which to choose. Individual action plans from the library/database of action plans 128 may be pre-customized for different industries, thus the action plans a law firm is likely to choose (involving docketing of court dates, deposition dates, filing deadlines and warnings thereof based upon feedback forms sent to and received from users indicating real world events in a legal matter or case) are likely to be very different from the action plans appropriate for a dentist's office (involving scheduling of check-up letters based upon feedback forms sent to and received from users indicating real world progress in the case of a given patient) and both are likely to be different from a car sales action plan, which will differ from other types of sales action plans, and so on. Forms generated by the device of the present invention may similarly be pre-programmed based upon the needs of a target class of likely users of the invention.

Note that for a given action plan, many steps will be common to other action plans. For example, action 8 of FIG. 3, the introductory letter in a two letter introduction series is likely to occur in a wide range of action plans. However, how such steps are assembled into a coherent and complete action plan will vary from plan to plan in a given database of action plans.

The action plans in a given database may further be customized by users. For example, a given set of users may have discovered that they have techniques which are advantageous when compared to the techniques in a pre-programmed action plan. In that event, users may customize or tailor action plans to suit their own needs, or may write entirely new action plans to add to the action plan database 108.

As noted several times, flow of work through an action plan changes based upon feedback from users, and may change in a very complex manner. FIG. 4 is an example of a combined action notice and feedback form according to a fourth embodiment of the present invention. In this embodiment, the action notice sent to a user indicating that it is time for event/action 30 (initial call/ask for an appointment, see FIG. 3) also includes the feedback form for the user to fill out. This form 400 also contains data from the third-party contact information database 104. In embodiments, the data may be all of the available contact information and intelligence available in the third-party contact information database 104, and data from other databases of the invention as desired.

Form 400 may also contain options based upon step of the action plan, based upon the current stage of the contact relationship, or based upon date, time, or identity of the representative or other parameters of interest to the user(s).

Field 401 of example form 400 is a title, indicating what the form is (a notice to make an initial call, event 30) and the identity of the exemplary user of whom the action is required: Joe A. Sample. Field 402 indicates the date of the action: 01-20-03 in the example. Fields 403, 404, 405, 406 and 407 respectively indicate the name, title and company, address, and contact information for the client to be contacted. A contact event history section (fields 408 and 409) has two parts: contact history field 408 and presumed next action field 409.

Fields 410 and 411 provide user defined information. In the “stand alone” embodiments of the invention, these fields are defined in the contact database provided as part of the invention. However, more interestingly, fields 410 and 411 also relate to the modular “plug-in” embodiments of the invention. In such embodiments, the user will define such information in the third-party database 104. In the example, no fields are user defined and so initial call notice/feedback request form 400 merely displays a reminder that the third-party vendor database (in the example ACT!) may have customized fields which may be displayed, used, merged into automatically prepared documents or otherwise handled just as if they were inherent in the database of the present invention.

Field 412 also may contain notes from the stand alone database or from a third-party database, or if empty, may merely display (as depicted) a notice that notes from the third-party database may be displayed if desired.

Field 413 states the purpose and objectives of the action to be undertaken, and remind the user that feedback is required to keep the action plan moving in accord with real world events which transpire during the telephone conversation. Fields 414 through 419 are the feedback fields to be used. There are a number of possible “presumed” responses, ranging from moving to action 47 of the same action plan, with a known time and place for an appointment, to action 41 (no further action at the present time but switch to an entirely different action plan suitable for potential future contacts), to various ‘wait’ responses which would continue the same action plan but in a different module (possibly a “wait” module such as depicted by block 206 of FIG. 2, and with a number of possible entry actions within that overall module), to a report of a failure to hold the conversation (moving to action 33), to other actions which the user may indicate “on the fly”

Field 420 and other fields may indicate reminders to the user, for example “!!!!!!!!!!ASK FOR REFERRALS!!!!!!!!!!” or hints on sales techniques or reminders of scripted points to raise or information to garner.

Users may of course tailor, customize or create new notices/feedback forms to suit their own situation. As previously alluded to briefly, feedback forms may comprise email, SMS, MMS, HTML, printed documents and so on. By this method the flexibility of the system may be greatly enhanced.

The invention obviously then incorporates a response module capable of sending and receiving back from a user an after-action feedback form, the after action feedback form having means for manually selecting at least one member of plurality of outcomes of an action. Thereafter, the action processing engine may be capable of altering the first action plan based upon the selected outcome of the action, in a manner described at length previously: selection of the appropriate next action in the plan, or entry to another module of the same plan, or even departure from the first action pan and initiation of a second action plan based upon the selected outcome of the action. Thus the action processing engine automatically responds flexibly to the user's manual after-action feedback.

Various supervisory functions may be included in alternative embodiments. Managers may view actions of various users regardless of the contact database in use to store that information. For example, a manual search module may be utilized by “supervisory users” to assess the overall status of a given representative's work, of a given sector of the clientele, results of particular modules or steps in an action plan or the efficiency of an entire action plan, and so on, even though the data may be stored in several different databases/devices/formats. Thus in one alternative embodiment the invention comprises a search module able to search through the action plan and further able to search through the database and retrieve therefrom information organized by one member selected from the group consisting of: the associated actions, the dates of associated actions, individuals associated with the associated actions, any data field present in the databases being searched, and combinations thereof. The invention may also incorporate a central information center allowing real time access to and review of the action plan database, the first action plan, the contact information database, and combinations thereof. By this means, supervisory personal may monitor the performance of the organization, individuals, types of action plans, types of actions and so on.

Obviously, the present examples are a drastically reduced subset of the universe of possible embodiments of the present invention. The structure and choice of programmed entities within the present invention (such as user interface 102 or event processing engine 118 or other components depicted in FIG. 1) may be varied without undue experimentation by those skilled in the art. Similarly, the overall flow of an action plan, choice of modules, and selection of actions within modules/action plans (such as depicted in FIG. 2 and FIG. 3) may be varied within the scope of the present invention without undue experimentation. Obviously, the layout and choice of information used, time sent, and other details relating to exemplary notice/feedback request 400 may also be varied. As an example, while notice/feedback request 400 is designed to deal with an initial call situation, numerous other existing and envisioned embodiments offer users notices for many, most or all actions in the action plans within the action plan database.

Thus, unlike known art, the present invention teaches contact management which comprises more than a mere “electronic Rolodex” (Trademark owner not associated with present applicant) but with flexibility not offered in a preprogrammed and rigid sales plan. The present invention teaches that at each step in an action plan, human feedback may be used to select from among a wide range of further action options. The present invention furthermore teaches that a wide variety of communication methods may be used to remind users of the need for such actions, and that a number of steps in such an action plan may be automatically initiated by the invention. The same wide array of communication methods may be used to gather the feedback. The present invention furthermore teaches that users may benefit from a library of action plans pre-tailored to suit a variety of industries and a variety of situations within a given industry. The present invention furthermore teaches that implementation of this software device may occur in a “plug-in” module which functions within the context of one or more other vendors' contact management suites, or as a stand alone product, or as a stand alone product able to directly utilize the information in databases formatted according to the contact management software of one or more other vendors.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A computer implemented action processing module for use with at least one third-party contact management device and associated third-party database containing contact information, the module comprising:
a computer having the following modules;
an action processing engine, the action processing engine operatively connected to a first third-party contact management device as a plug-in module, the action processing engine furthermore operatively connected to a first associated third-party database so as to access such contact information;
the action processing engine furthermore operatively connected to the first associated third-party database so as to alter such contact information stored in the first associated third-party database; and
a pre-programmed action plan database containing pre-programmed first and second action plans usable without user programming and further usable without user scheduling, the first action plan indicating at least one action associated with specified combinations of the contact information and at least one date; wherein
the action processing engine searches the first third-party database for the specified combinations of the contact information and date; and
upon finding the specified combinations, the action processing engine initiates the associated actions.

2. The action processing module of claim 1, wherein the action processing engine is operatively connected to the first third-party contact management device by a first module to contact management device interface.

3. The action processing module of claim 1, wherein the action processing engine is operatively connected to the first associated third-party database by a first module to database interface.

4. The action processing module of claim 2, wherein the first module to contact management device interface is able to operatively connect the first module to a second third-party contact management device.

5. The action processing module of claim 3, wherein the first module to database interface is able to operatively connect the first module to a second third-party database.

6. The action processing module of claim 4, wherein
the action processing engine is operatively connected with a first third-party contact management device having a first third-party database and with a second third-party contact management device having a second third-party database, and further wherein
the action processing engine searches the first and second third-party databases for the specified combinations of the contact information and the associated dates; and further wherein
upon finding the specified combinations in either one of the first and the second third-party database, the action processing engine initiates the associated actions.

7. The action processing module of claim 5, wherein
the action processing engine is operatively connected with a first third-party database and with a second third-party database, and further wherein
the action processing engine searches the first and second third-party databases for the specified combinations of the contact information and the associated dates; and further wherein
upon finding the specified combinations in either one of the first and the second third-party database, the action processing engine initiates the associated actions.

8. The action processing module of claim 1, further comprising:
a search module able to search through the action plan and further able to search through the database and retrieve therefrom information organized by one member selected from the group consisting of: the associated actions, the dates of associated actions, individuals associated with the associated actions, any data field present in the databases being searched, and combinations thereof.

9. The action processing module of claim 1, further comprising means for communication between the action plan and at least one human being.

10. The action processing module of claim 9, wherein the means for communication between the action plan and at least one human being further comprises at least one member selected from the group consisting of: notifying an individual associated with an action of the need to undertake the action, updating the information in an action plan, updating such contact information in the third party database, requesting updates of real world actions from individuals associated with an action, updating contact information in a personal database associated with an individual associated with an action, automatically merging data from such third party database with data from the action plan, automatically sending e-mail, automatically sending voice messages, automatically printing written communications, automatically sending facsimile transmissions, automatically sending text messages, requesting signing of automatically printed documents, requesting mailing of automatically printed documents, and combinations thereof.

11. The action processing module of claim 9, wherein the at least one human being further comprises one member selected from the group consisting of: users, clients, customers, supervisors, and combinations thereof.

12. The action processing module of claim 1, further comprising:
a form library containing a plurality of forms pre-programmed based upon the needs of a target class of likely users of the invention.

13. The action process module of claim 1, further comprising:
a form processing module capable of undertaking at least one action selected from the group consisting of: automatically merging data from such third party database with data from the action plan, automatically sending e-mail, automatically sending voice messages, automatically printing written communications, automatically sending facsimile transmissions, automatically sending text messages, requesting signing of automatically printed documents, requesting mailing of automatically printed documents, conversion of automatically created documents to a specified file type, saving of automatically created documents, and combinations thereof.

14. The action processing module of claim 1, further comprising:
a human interface module capable of sending and receiving a message, the type of message being one member selected from the group consisting of: e-mail messages, text messages, voice mail, printed communications and combinations thereof.

15. The action process module of claim 1, further comprising
a response module capable of sending and receiving back from a user an after-action feedback form, the after action feedback form having means for selecting at least one member of plurality of outcomes of an action.

16. The action processing module of claim 14, wherein the action processing engine is capable of altering the first action plan based upon the selected outcome of the action.

17. The action processing module of claim 13, wherein the action processing engine is capable of departing from the first action plan and initiating a second action plan based upon the selected outcome of the action.

18. The action processing module of claim 1, further comprising:
a central information center allowing real time access to and review of the action plan database, the first action plan, the contact information database, and combinations thereof.

19. The action processing module of claim 1, wherein the first third-party contact management device is one member selected from the group consisting of: contact management software, sales force automation software, software having a contact database, personal digital assistants having contact databases, enterprise software, and combinations thereof.

20. An action plan database for users of contact management software which manages dates and contact information, the database comprising:
a computer having the database stored thereon;
a plurality of pre-programmed action plans, the action plans indicating at least one action associated with specified combinations of such contact information and such dates;
wherein the action plans are operatively connected to the contact management software; and
wherein users may select at least one action plan for use with the contact management software.

21. An improved action plan for contact management software, wherein the improvement comprises:
a response module capable of sending and receiving back from a user an after-action feedback form, the after action feedback form having means for selecting at least one member of plurality of outcomes of an action, wherein the contact management software is capable of altering the first action plan based upon the selected outcome of the action.

22. An improved contact management device, wherein the improvement comprises:
a form processing module capable of undertaking at least one action selected from the group consisting of: automatically merging data from such third party database with data from the action plan, automatically sending e-mail, automatically sending voice messages, automatically printing written communications, automatically sending facsimile transmissions, automatically sending text messages, requesting signing of automatically printed documents, requesting mailing of automatically printed documents, conversion of automatically created documents to a specified file type, saving of automatically created documents, and combinations thereof.
